(19) United States
(12) Patent Application Publication
(10) Pub. No.: US 2025/0128849 A1
(43) Pub. Date: Apr. 24, 2025

(54) LABEL ATTACHING APPARATUS, LABEL ATTACHING METHOD, AND PROGRAM

(71) Applicant: SATO HOLDINGS KABUSHIKI KAISHA, Tokyo (JP)

(72) Inventor: Hiroaki HORIGOME, Minato-ku (JP)

(73) Assignee: SATO HOLDINGS KABUSHIKI KAISHA, Tokyo (JP)

(21) Appl. No.: 18/691,653

(22) PCT Filed: Sep. 6, 2022
(86) PCT No.: PCT/JP2022/033468

§ 371 Date: Mar. 13, 2024

(30) Foreign Application Priority Data
Sep. 29, 2021 (JP) 2021-159242

(51) Int. Cl. B65C 1/02; B65C 9/26; B65C 9/40

(52) U.S. Cl. CPC B65C 1/021; B65C 9/26; B65C 9/40

(57) ABSTRACT

A label attaching apparatus for attaching a label to an adherend, including: a measurement unit that measures a shape of the adherend; and an attachable region determination unit that determines an attachable region of the label on the adherend based on the shape.

### TECHNICAL FIELD

The present invention relates to a label attaching apparatus, a label attaching method, and a program.

### BACKGROUND ART

JP2014-105019A discloses a film packaging apparatus that covers and packages a product with a film. The film packaging apparatus disclosed in Patent Literature 1 detects a tray size, reads tray information corresponding to the detected tray size, and executes film packaging on a tray based on the tray information. The film packaging apparatus is configured to attach a label in a predetermined orientation to an attachment position defined based on the tray information on the product packaged with a film.

### SUMMARY OF INVENTION

In the film packaging apparatus disclosed in JP2014-105019A, a size and a shape of a product to be packaged with a film are determined in advance as the tray information. In addition, the attachment position of the label with respect to the product is also defined in advance based on the tray information.

Therefore, the film packaging apparatus disclosed in JP2014-105019A cannot attach a label to a product for which information such as a size and a shape is not prepared in advance.

Therefore, an object of the present invention is to allow a label to be attached to an adherend having any shape and any size at an appropriate position.

According to an aspect of the present invention, there is provided a label attaching apparatus for attaching a label to an adherend, including: a measurement unit that measures a shape of the adherend; and an attachable region determination unit that determines an attachable region of the label on the adherend based on the shape.

According to the above-mentioned aspect, since the shape of the adherend is specified, and the attachable region of the label is determined based on the specified shape, the label can be attached to an adherend having any shape and any size at an appropriate position.

### BRIEF DESCRIPTION OF DRAWINGS

FIG. 1 is a diagram illustrating a configuration example of a label attaching apparatus according to an embodiment of the present invention.

FIG. 2 is a block diagram illustrating the label attaching apparatus according to the embodiment of the present invention.

FIG. 3 is a flowchart illustrating a label attaching process executed in the label attaching apparatus.

FIG. 4 is a schematic diagram illustrating a measured shape of an adherend and a determined attachable region.

FIG. 5 is a schematic diagram illustrating a process of setting a new slice line and determining an attachable region based on the new slice line.

FIG. 6 is a schematic diagram illustrating that the attachable region is determined based on the slice line and a label is attached to the attachable region.

FIG. 7 is a schematic diagram illustrating that the attachable region is determined based on the slice line and the label is attached to the attachable region.

FIG. 8 is a schematic diagram illustrating that the attachable region is determined based on the slice line and the label is attached to the attachable region.

### DESCRIPTION OF EMBODIMENTS

Hereinafter, a label attaching apparatus according to an embodiment of the present invention will be described with reference to the drawings.

### [Label Attaching Apparatus]

A label attaching apparatus 1 according to the present embodiment is a device that includes a measurement unit that measures a shape of the adherend, and an attachable region determination unit that determines an attachable region of the label on the adherend based on the shape, thereby attaching the label to the attachable region determined based on the shape of the adherend.

In the present embodiment, the adherend is an article packaged with a packaging material, and the shape of the adherend is a shape of the packaging material that covers the article.

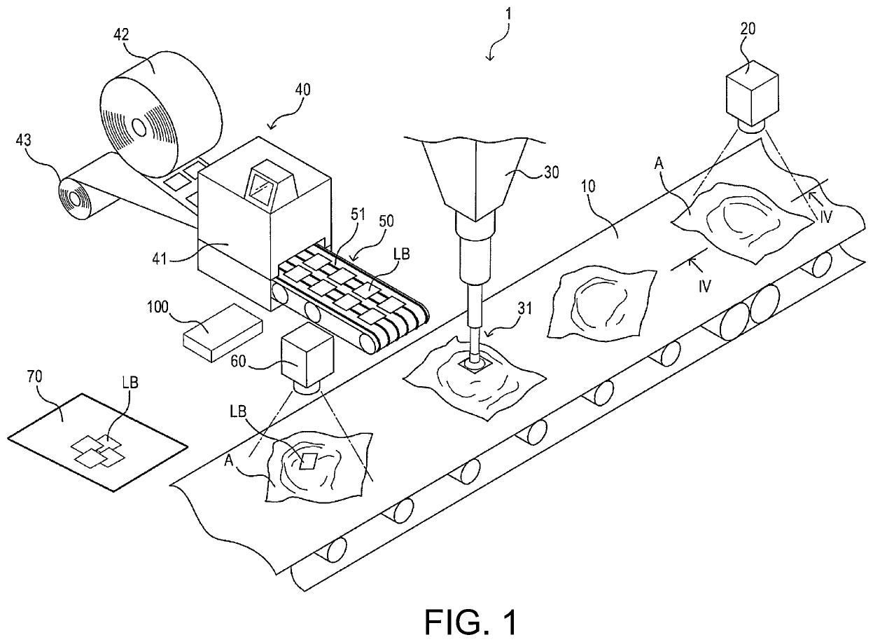

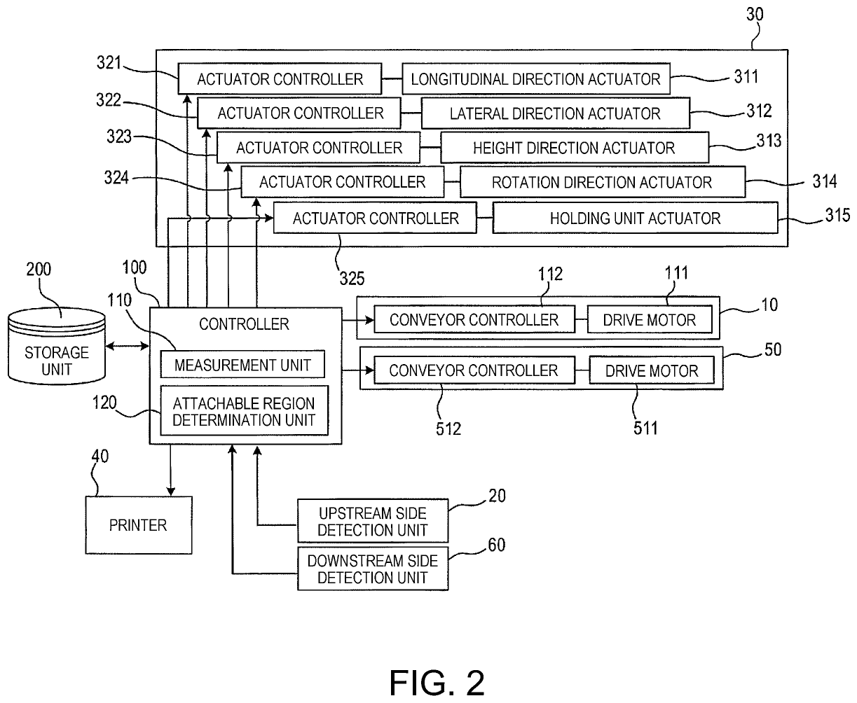

FIG. 1 is a schematic diagram illustrating a configuration example of the label attaching apparatus 1 according to the present embodiment. FIG. 2 is a block diagram illustrating the label attaching apparatus 1.

The label attaching apparatus 1 includes an adherend conveying unit 10 that conveys an adherend A, an upstream side detection unit 20 for acquiring data related to a shape of the adherend A, and an attachment arm 30 for attaching a label LB to the adherend A.

In addition, the label attaching apparatus 1 includes a printer 40 serving as a printing unit that executes printing on the label LB, a label conveying unit 50 for conveying the label LB subjected to printing by the printer 40, and a downstream side detection unit 60 that is provided on a downstream side of the attachment arm 30 and detects the adherend A.

Further, the label attaching apparatus 1 includes a controller 100 for generally controlling each of the above-described configurations. In the present embodiment, the measurement unit 110 that measures the shape of the adherend A and the attachable region determination unit 120 that determines the attachable region of the label LB on the adherend A are achieved as functional configurations of the controller 100.

Next, each of the above-described configuration in the label attaching apparatus 1 will be described.

The adherend conveying unit 10 conveys a plurality of adherends A individually and continuously. Accordingly, the label attaching apparatus 1 can attach the label LB to the adherend A while conveying the adherend A.

As illustrated in FIG. 2, the adherend conveying unit 10 includes a drive motor 111 that drives the adherend conveying unit 10, and a conveyor controller 112 that controls driving of the drive motor 111. A conveyance speed of the adherend A by the adherend conveying unit 10 is appropriately controlled by the controller 100.

The upstream side detection unit 20 is disposed on an upstream side of the adherend conveying unit 10. In the present embodiment, a 3D camera can be used as the upstream side detection unit 20. The upstream side detection unit 20 can capture an image of the adherend A before the label LB is attached. Data of the image captured by the upstream side detection unit 20 is used to determine whether the adherend A is put into the adherend conveying unit 10, and to determine an attachable region in which the label LB is attached in the adherend A.

The attachment arm 30 includes a label holding unit 31 that picks up the label LB conveyed by the label conveying unit 50 with an adhesive surface facing an adherend A side.

The attachment arm 30 includes an actuator capable of moving in a longitudinal direction, a lateral direction, and a height direction. As illustrated in FIG. 2, the attachment arm 30 includes a longitudinal direction actuator 311, a lateral direction actuator 312, a height direction actuator 313, and a rotation direction actuator 314. In addition, the attachment arm 30 includes actuator controllers 321, 322, 323, and 324 that control driving of the above-mentioned actuators.

The longitudinal direction actuator 311 is an actuator that is driven in a conveyance direction of the adherend conveying unit 10. The lateral direction actuator 312 is an actuator that is driven in a direction intersecting the conveyance direction of the adherend conveying unit 10. The height direction actuator 313 is an actuator that is driven in a normal direction of a conveyance surface of the adherend conveying unit 10. The rotation direction actuator 314 is an actuator that is driven in a rotation direction considering a normal of the conveyance surface of the adherend conveying unit 10 as its axis.

Further, the attachment arm 30 includes a holding unit actuator 315 that inserts and removes the label holding unit 31 in the normal direction of the conveyance surface of the adherend conveying unit 10, and an actuator controller 325 that controls driving of the holding unit actuator 315.

By including the respective actuators described above, the attachment arm 30 can move the label LB to the adherend A and attach the label LB to a predetermined position of the adherend A.

The label holding unit 31 includes, although not illustrated in the present embodiment, a structure for sucking and holding the label LB at a tip end portion. The label holding unit 31 is provided with a vacuum sensor (not illustrated). It is possible to detect whether the label LB is sucked to the label holding unit 31 based on a threshold value of the vacuum sensor. In addition, since the tip end portion of the label holding unit 31 which comes into contact with the label LB is formed of a flexible material, the label LB which is flexed and deformed following a surface shape of the adherend A can be held.

Since the label holding unit 31 has such a structure, even when the label holding unit 31 is pressed against the label LB when the label LB is picked up from the label conveying unit 50 or when the label LB is attached to the adherend A, the label LB is not damaged.

The label holding unit 31 is formed to be stretchable in an attachment direction in which the label LB is attached to the adherend A. Accordingly, when the label LB is attached to the adherend A, the label holding unit 31 comes into contact with the adherend A, contracts in the attachment direction, and can absorb a stress at the time of attaching, so that damage to the adherend A can be prevented.

The printer 40 includes a printer main body 41 that prints necessary information on the label LB, a label roll 42 in which the label LB before printing is temporarily attached to a continuous body of a separator, and a mount roll 43 in a state where the continuous body of the separator after the label LB is peeled off is collected.

In the present embodiment, the printer 40 is a printer capable of independently setting and printing print contents related to the adherend A without being connected to an information processing terminal such as a personal computer.

Since the label attaching apparatus 1 includes the printer 40, information related to the adherend A can be printed on the label LB before attaching. Examples of the information related to the adherend A include, for food products, a date of manufacture, an expiration date, and names of raw materials.

The label conveying unit 50 includes a conveying belt 51 that conveys the label LB peeled off from the continuous body of the separator, and conveys the plurality of labels LB individually and continuously. As illustrated in FIG. 2, the label conveying unit 50 includes a drive motor 511 that drives the label conveying unit 50, and a conveyor controller 512 that controls driving of the drive motor 511.

The downstream side detection unit 60 is disposed on the downstream side of the attachment arm 30 in the adherend conveying unit 10. In the present embodiment, the downstream side detection unit 60 is a camera that captures an image of the adherend A after the label LB is attached. Data of the image captured by the downstream side detection unit 60 is used in a process of determining an attachment state of the label LB in the controller 100.

Next, the controller 100 will be described.

The controller 100 is a computer including a microprocessor, storage units such as a read only memory (ROM) and a random access memory (RAM), an input/output interface, and a bus connecting those.

As illustrated in FIG. 2, the controller 100 includes, as functional configurations, the measurement unit 110 that measures the shape of the adherend A, and the attachable region determination unit 120 that determines an attachable region of the label LB on the adherend A based on the measured shape.

The measurement unit 110 acquires image data including three-dimensional information from the upstream side detection unit 20 as data related to the shape of the adherend A. The measurement unit 110 can acquire height information of the adherend A as a target and size information such as a length and a width of the adherend based on the image data. The measurement unit 110 calculates a parameter based on the height of the adherend A from the placement surface of the adherend conveying unit 10 on which the adherend A is placed, and measures the shape of the adherend A using the parameter.

The attachable region determination unit 120 determines, as the attachable region of the label LB, a region in which the height of the adherend A from the placement surface measured by the measurement unit 110 is equal to or greater than a threshold value (hereinafter, may be referred to as a slice line) and which has an area allowing the label LB of a predetermined size to be attached.

In a case where the height of the adherend A from the placement surface is less than the slice line, the attachable region determination unit 120 sets a value obtained by subtracting a certain value from a highest value of the height of the adherend A from the placement surface as a new slice line.

The attachable region determination unit 120 determines a position at which the label LB is attached with reference to a center of the determined attachable region.

In addition, the attachable region determination unit 120 can determine a position at which the label LB is attached to the adherend A such that the center of the attachable region corresponds to a center of the label LB.

Even when irregularities, gaps, or the like are present on a surface of the adherend A, the label LB may be able to be adhered and held due to an adhesive force of the label LB and deflection of the label LB. Therefore, in the present embodiment, a displacement of height on the surface of the adherend A to an extent that the label LB can be adhered to and held by the adherend A due to the adhesive force of the label LB and the deflection of the label LB is treated as an attachment allowable displacement, and can be selected as the attachable region.

In the controller 100, the above-described processes executed by the measurement unit 110 and the attachable region determination unit 120 are stored in the ROM of the controller 100 or a storage unit 200 as a program executable in the microprocessor.

The storage unit 200 is a storage medium readable by the controller 100. The storage unit 200 may be configured to be attachable to and detachable from the label attaching apparatus 1.

In addition, a range of values of the size of the label LB, the slice line, and the irregularities, the gaps, or the like handled as the attachment allowable displacement is stored in the ROM or the storage unit 200 as a default value. Further, the above can be set and changed from outside of the controller 100.

By executing a control program stored in the ROM or the storage unit 200 in the microprocessor, the controller 100 can execute a process for operating the attachment arm 30 and a process of adjusting the conveyance speed of the adherend conveying unit 10.

In the present embodiment, the controller 100 generates control signals for the actuators (longitudinal direction actuator 311, lateral direction actuator 312, height direction actuator 313, rotation direction actuator 314, and holding unit actuator 315) and the drive motors (drive motor 111 and drive motor 511), and supplies the control signals to the respective controllers (actuator controllers 321, 322, 323, 324, and 325 and conveyor controllers 112 and 512) via the input/output interface.

In addition, by executing the control program stored in the ROM or the storage unit 200 in the microprocessor, the controller 100 can determine whether the label LB is attached to the adherend A based on the image data of the adherend A acquired in the downstream side detection unit 60.

The controller 100 can detect the label LB by detecting characteristics representing the label LB such as the shape and a color of the label LB based on the image data of the adherend A acquired in the downstream side detection unit 60. Data related to the characteristics such as the shape and the color of the label LB is stored in the ROM or the storage unit 200. In addition, the data related to the characteristics such as the shape and the color of the label LB can be set and changed via the input/output interface.

In a case where the label LB on the adherend A is not detected based on the image data from the downstream side detection unit 60, the controller 100 executes an error handling process in which the label LB that is unattachable to the adherend A is discarded to the discarding region 70 (see FIG. 1) provided at a position different from the adherend conveying unit 10.

In another error handling process, the controller 100 can attach the label LB that is unattachable to the adherend A to an adherend A to be conveyed next to the adherend A.

In some cases, the attachable region determination unit 120 may not be able to determine the attachable region of the adherend A. In such cases, the controller 100 executes a process for causing the adherend A to retract to the outside of the label attaching apparatus 1 without attaching the label LB to the adherend A for which the attachable region cannot be determined.

As an example of a retraction process, the controller 100 can stop the adherend conveying unit 10 and notify a user of an error message such as “please reput a product that could not be measured” by a notification unit (not illustrated).

Since the controller 100 has the above-described function, the controller 100 can determine the attachable region of the label LB on the adherend A based on the measured shape of the adherend A. Therefore, the label LB can be attached to an appropriate position of the adherend A even for the adherend A for which information such as the size of the adherend A and the shape of the adherend A is not prepared in advance.

### [Label Attaching Method]

Next, a label attaching method by the label attaching apparatus 1 will be described.

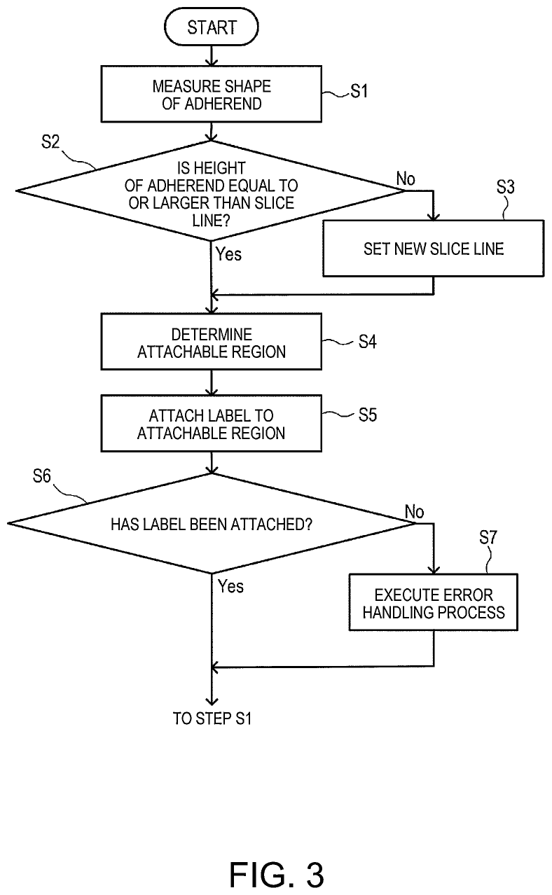

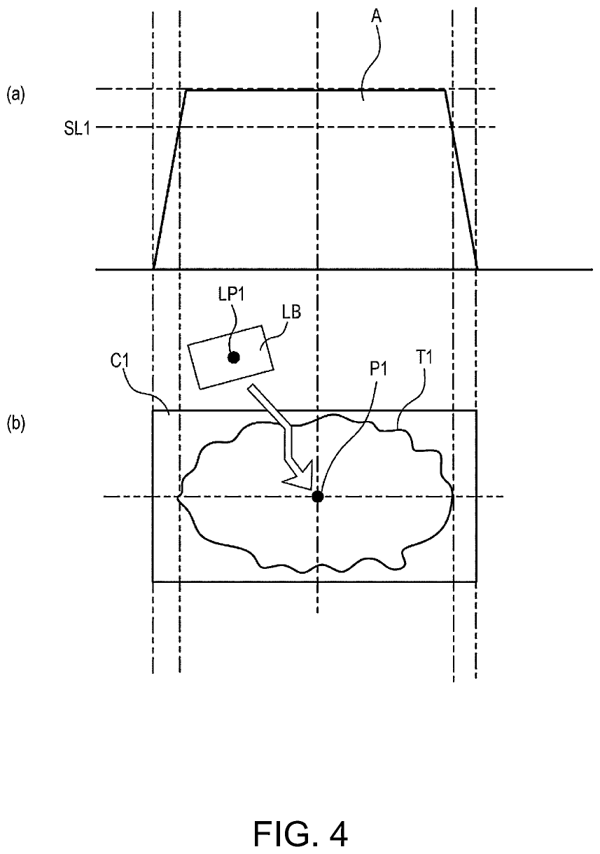

FIG. 3 is a flowchart illustrating a label attaching process executed in the label attaching apparatus 1. FIG. 4 is a diagram illustrating the shape of the adherend A measured by the measurement unit 110 using the parameter based on the height of the adherend A from the placement surface of the adherend conveying unit 10, and an attachable region T1 determined based on a slice line SL1.

The label attaching method according to the present embodiment is executed in the label attaching apparatus 1 based on a process of determining the attachable region of the label LB.

In step S1, the controller 100 causes the measurement unit 110 to acquire image data acquired from above the adherend A by the 3D camera serving as the upstream side detection unit 20. Then, the controller 100 measures the shape of the adherend A using the parameter based on the height of the adherend A from the placement surface on which the adherend A is placed, which is obtained based on the acquired image data.

An object (a) of FIG. 4 illustrates a cross-sectional shape taken along a line IV-IV of the adherend A illustrated in FIG. 1, and an object (b) of FIG. 4 illustrates a shape C1 of the adherend A and the attachable region T1 determined based on the slice line SL1.

The parameter based on the height is data of a measured value of a distance from the placement surface to the surface of the adherend A, data obtained by digitizing a height difference with respect to a predetermined reference value of the surface of the adherend A, or the like. In the present embodiment, the data of the measured value of the distance from the placement surface to the surface of the adherend A is used.

By using the data of the measured value of the distance from the placement surface to the surface of the adherend A, the controller 100 measures the shape C1 as a shape obtained by projecting the entire adherend A onto a plane in step S1.

Next, in step S2, the controller 100 compares a slice line SL1 set in advance with the height of the adherend A. That is, in a case where the controller 100 determines that the data of the measured value of the distance from the placement surface of the adherend A to the surface of the adherend A has coordinates that reach a height of the slice line SL1 set in advance (Yes in step S2) by the attachable region determination unit 120, the process proceeds to step S4.

In step S4, as illustrated in the object (b) of FIG. 4, the controller 100 determines, by the attachable region determination unit 120, a region that is equal to or larger than the slice line SL1, satisfies the attachment allowable displacement, and has an area to which the label LB of a predetermined size can be attached as the attachable region T1 of the label LB.

Next, in step S5, as illustrated in the object (b) of FIG. 4, the controller 100 attaches the label LB to the adherend A such that a center P1 of the determined attachable region T1 corresponds to a center LP1 of the label LB.

On the other hand, in step S2, in a case where the controller 100 determines that there is no coordinate at which the height of the adherend A reaches the height of the slice line SL1 set in advance (No in step S2), the process proceeds to step S3.

In step S3, the controller 100 sets a new slice line SL2 by the attachable region determination unit 120.

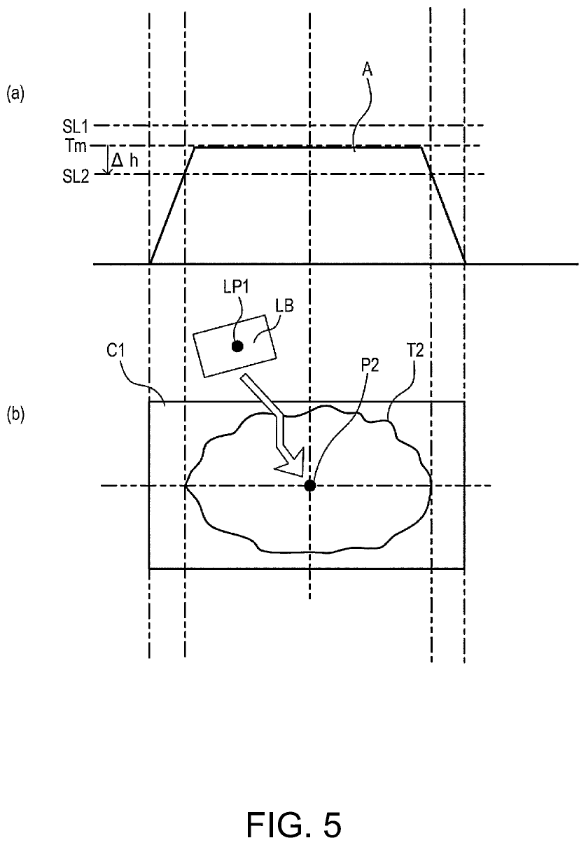

FIG. 5 is a schematic diagram illustrating a process of setting the new slice line SL2 and setting an attachable region T2 based on the slice line SL2.

In step S3, the attachable region determination unit 120 sets a value obtained by subtracting a predetermined value Δh from the highest value (Tm illustrated in FIG. 5) of the height from the placement surface of the adherend A as the new slice line SL2.

Next, in step S4, as illustrated in an object (b) of FIG. 5, the controller 100 determines, by the attachable region determination unit 120, a region that is equal to or larger than the slice line SL2, satisfies the attachment allowable displacement, and has an area to which the label LB of a predetermined size can be attached as the attachable region T2 of the label LB.

In step S1, the controller 100 can acquire the data of the measured value of the distance from the placement surface to the surface of the adherend A, and therefore, as illustrated in the object (b) of FIG. 5, the shape obtained by projecting the entire adherend A onto a plane is the shape C1.

In step S5, the controller 100 attaches the label LB to the attachable region T2 such that a center P2 of the determined attachable region T2 corresponds to the center LP1 of the label LB.

Next, in step S6, the controller 100 determines whether the label LB has been attached to the adherend A.

In step S6, in a case where it is determined that the label LB has not been attached to the adherend A (No in step S6), the controller 100 executes an error handling process in step S7.

In the error handling process in step S7, the controller 100 discards the label LB that could not be attached to the discarding region 70 provided at a position different from the adherend conveying unit 10. After the error handling process is executed, the controller 100 repeats the processes from step S1.

In step S7 in the present embodiment, another error handling process can also be executed. In the another error handling process, in a case where the vacuum sensor provided in the label holding unit 31 detects that the label LB remains in the label holding unit 31, the controller 100 attaches the label LB that could not be attached to the adherend A to a next adherend A.

In the label attaching process described above, in step S1, the upstream side detection unit 20 may fail to acquire the image data, the measurement unit 110 may not be able to receive the image data from the upstream side detection unit 20, or the measurement unit 110 may not be able to measure the shape of the adherend A. In addition, in step S4, it may be impossible to determine the attachable region of the adherend A by the attachable region determination unit 120.

In order to handle such errors, it is possible to set a step of setting an error flag when there is an error in each process and a step of detecting the error flag.

When the error flag is detected, the controller 100 can execute a process for causing the adherend A to which the label LB could not be attached to retract to the outside of the label attaching apparatus 1.

As an example of the retraction process, the controller 100 stops the adherend conveying unit 10 and notifies the user of an error message such as “please reput a product that could not be measured”.

In this manner, since the adherend A to which the label LB could not be attached due to an error is put into the label attaching apparatus 1 again, it is possible to prevent a failure that the adherend A is distributed in a state where the label LB is not attached.

By executing the above processes, the label attaching apparatus 1 can determine the attachable regions T1 and T2 of the label LB on the adherend A based on the measured shape of the adherend A. Accordingly, even for an adherend A for which information such as a size of the adherend A and a shape of the adherend A is not prepared in advance, the label attaching apparatus 1 can accurately attach the label LB to an appropriate position on the adherend A.

According to the label attaching apparatus 1 of the present embodiment, since the attachable regions T1 and T2 of the label LB are determined based on the slice line and the position to which the label LB is attached is determined with reference to the centers of the attachable regions T1 and T2, it is possible for the user to attach the label LB to the adherend A with good appearance.

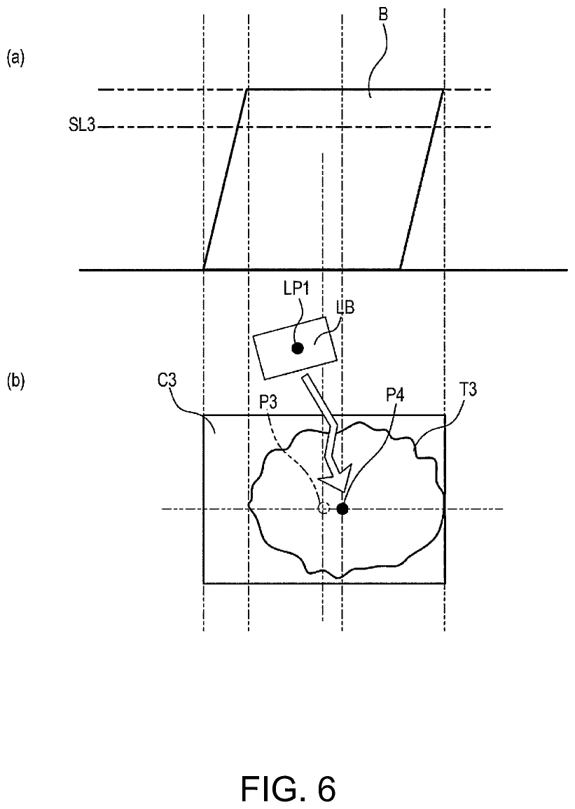

FIG. 6 is a schematic diagram illustrating that, with respect to an adherend B, an attachable region T3 is determined based on a slice line SL3, and the label LB is attached in the attachable region T3.

The adherend B illustrated in FIG. 6 has a shape in which a lower surface and an upper surface are off set in the normal direction, and has a substantially rhombus cross section. In the adherend B, according to the image data acquired from above by the 3D camera serving as the upstream side detection unit 20, an outline of the adherend B is measured as a shape C3 illustrated in an object (b) of FIG. 6.

On the other hand, the attachable region T3 is determined based on the slice line SL3 by the attachable region determination unit 120.

In FIG. 6, a center P3 based on the outline (shape C3) of the adherend B is at a position deviated from a center P4 of the attachable region T3. For example, in a label attaching apparatus that determines an attachment position of a label based on only image data of a 3D camera above without applying a slice line, the label may be attached based on the center P3 of the shape C3, and the user may be given an impression that the label is attached in a deviated manner.

On the other hand, according to the label attaching apparatus 1 of the present embodiment, the label LB can be attached to the adherend B such that the center P4 of the attachable region T3 determined based on the slice line SL3 corresponds to the center LP1 of the label LB.

Accordingly, the user can be given an impression that the label is attached to an appropriate position.

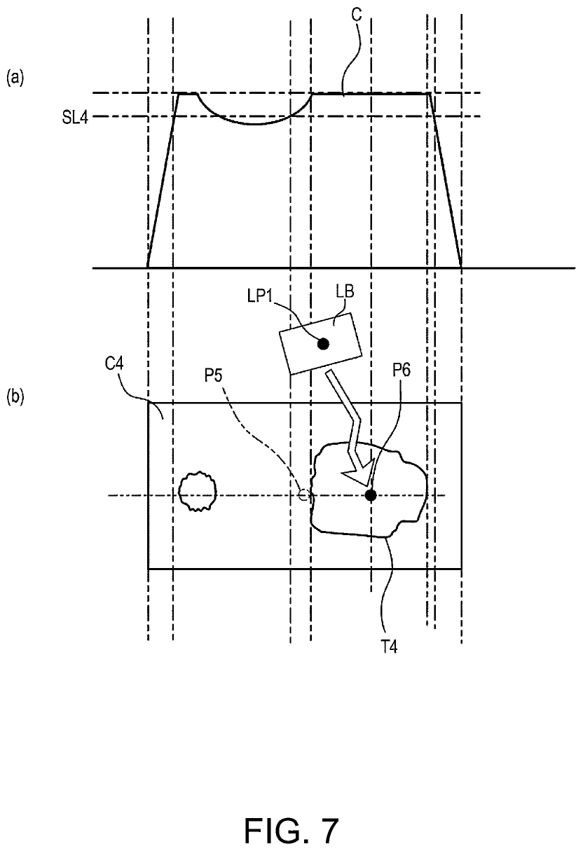

FIG. 7 is a schematic diagram illustrating that, with respect to an adherend C, an attachable region T4 is determined based on a slice line SL4, and the label LB is attached in the attachable region T4.

The adherend C illustrated in FIG. 7 has irregularities exceeding the attachment allowable displacement on an upper surface. In the adherend C, according to the image data acquired from above by the 3D camera serving as the upstream side detection unit 20, an outline of the adherend C is measured as a shape C4 illustrated in an object (b) of FIG. 7.

On the other hand, the attachable region T4 is determined based on the slice line SL4 by the attachable region determination unit 120.

In FIG. 7, a center P5 based on the outline (shape C4) of the adherend C is at a position deviated from a center P6 of the attachable region T4. Therefore, in a label attaching apparatus that determines an attachment position of a label based on only image data of an upper 3D camera, even when the attachment position is determined based on a position of the center P5, the label may not be attached to the position.

In contrast, according to the label attaching apparatus 1 of the present embodiment, the label LB can be attached to the adherend C such that the center P6 of the attachable region T4 determined based on the slice line SL4 corresponds to the center LP1 of the label LB.

Accordingly, the label LB can be accurately attached to the attachable region T4. In addition, the user can be given an impression that the label is attached to an appropriate position.

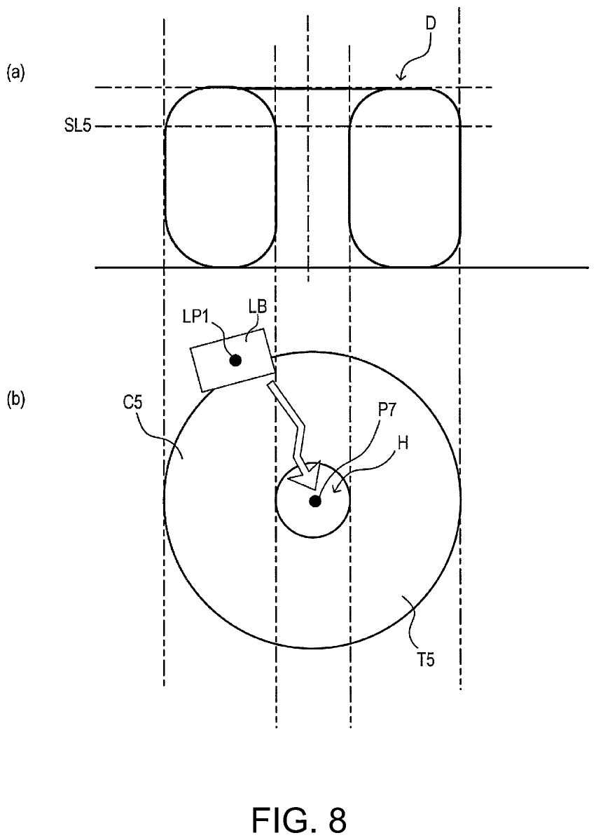

FIG. 8 is a schematic diagram illustrating that, with respect to an adherend D, an attachable region T5 is determined based on a slice line SL5, and the label LB is attached in the attachable region T5.

The adherend D illustrated in FIG. 8 has a doughnut shape in which an empty area H is formed at the center. According to the label attaching apparatus 1 of the present embodiment, the attachable region T5 determined based on the slice line SL5 overlaps an outline (shape C5) of the adherend D, and it can be detected that the empty area H is continuously surrounded by a part of the adherend D.

Therefore, the label attaching apparatus 1 can determine that a surface of the packaging material is continuously present also on the empty area H, and handle the attachable region T5 as a circular surface without the empty area H.

Accordingly, according to the label attaching apparatus 1, even when the empty area H is present at the center of the attachable region T5, the label LB can be attached to the adherend D in a manner that a center P7 of the attachable region T5 determined based on the slice line SL5 and the center LP1 of the label LB correspond to each other such that the label LB is located on the surface of the packaging material corresponding to an upper surface of the empty area H.

Accordingly, the user can be given an impression that the label LB is attached to an appropriate position.

As described above, according to the label attaching apparatus 1, even when shapes of the adherends are different from each other, an attachable region corresponding to the shape of the adherend can be determined, and the label LB can be attached at an appropriate position in the attachable region.

### [Label Attaching Program]

The label attaching method described above can also be provided as a program executable by the microprocessor in the controller 100 of the label attaching apparatus 1.

That is, the program according to the present embodiment is a program for causing a computer to execute a procedure of specifying the shape of each adherend A to be conveyed and a procedure of determining the attachable region T1 of the label LB on the adherend A based on the shape of the adherend A.

The program is stored in the ROM of the controller 100 or the storage unit 200.

### [Other Embodiments]

Although the embodiments of the present invention have been described above, the above embodiments are merely a part of application examples of the present invention, and are not intended to limit the technical scope of the present invention to the specific configuration of the above embodiments.

In the label attaching apparatus 1, the upstream side detection unit 20 for acquiring data related to the shape of the adherend A may be a sensor that irradiates an object with red light, laser light, or the like and measures a distance based on a reflection time thereof.

In the label attaching apparatus 1, the way of conveying the label LB in the label conveying unit 50 is not limited to a mode described in FIG. 1.

In the present embodiment, the printer 40 may be a printer that is connected to an information processing device such as a personal computer (PC) (not illustrated), and capable of receiving an input of information related to the adherend A from a user via the PC and executing setting of the printer 40 itself.

In the label attaching apparatus 1, the controller 100 may determine whether the attachment position of the label LB is within an allowable range together with a process of determining whether the label LB is attached to the adherend A.

When it is determined that the attachment position of the label LB on the adherend A is not within the allowable range, for example, the controller 100 notifies the user of an error message indicating that the label is not attached by a notification unit (not illustrated).

In the present embodiment, as illustrated in FIGS. 4 to 8, the attachable region T may not necessarily be a region that is substantially horizontal to the placement surface of the adherend A. As long as in a surface state in which the label LB can be adhered to and held by the adherend A due to the adhesive force of the label LB and the deflection of the label LB, the attachable region may be inclined with respect to the placement surface.

In a case where the adherends A to D are products packaged by a packaging material, surfaces of the adherends A to D have a shape in which a part of the shape of the product appears, and include those not having a smooth surface as illustrated in FIGS. 4 to 8.

The present application claims priority under Japanese Patent Application No. 2021-159242 filed to the Japan Patent Office on Sep. 29, 2021, and the entire content of this application is incorporated herein by reference.

1. A label attaching apparatus for attaching a label to an adherend, comprising:
a measurement unit configured to measure a shape of the adherend; and
an attachable region determination unit configured to determine an attachable region of the label on the adherend based on the shape.

2. The label attaching apparatus according to claim 1, wherein
the measurement unit measures the shape by using a parameter based on a height of the adherend from a placement surface on which the adherend is placed, and
the attachable region determination unit determines a region in which the parameter is equal to or greater than a threshold value as the attachable region.

3. The label attaching apparatus according to claim 2, wherein
the attachable region determination unit sets, as the threshold value, a value obtained by subtracting a predetermined value from a highest value of the height of the adherend from the placement surface.

4. The label attaching apparatus according to claim 1, wherein
the attachable region determination unit determines a position at which the label is attached with reference to a center of the attachable region.

5. The label attaching apparatus according to claim 4, wherein
the attachable region determination unit determines the position at which the label is attached such that the center of the attachable region corresponds to a center of the label.

6. The label attaching apparatus according to claim 1, further comprising:
an adherend conveying unit configured to individually and continuously convey a plurality of the adherends;
a label conveying unit configured to individually and continuously convey a plurality of the labels; and
a label holding unit configured to pick up the label conveyed by the label conveying unit with an adhesive surface thereof facing an adherend side, wherein
the measurement unit is configured to measure a shape of each of the adherends, and
the attachable region determination unit is configured to determine the attachable region of the label on the adherend based on each shape, and
attach the label picked up by the label holding unit to the attachable region.

7. The label attaching apparatus according to claim 6, further comprising:
a downstream side detection unit configured to detect the label attached to the adherend, wherein
in a case where the label on the adherend is not detected by the downstream side detection unit, an unattachable label is attached to an adherend to be conveyed next to the adherend to which the label is not attached.

8. The label attaching apparatus according to claim 6, further comprising:
a downstream side detection unit configured to detect the label attached to the adherend, wherein
in a case where the label on the adherend is not detected by the downstream side detection unit, an unattachable label is discarded in a discarding region provided at a position different from the adherend conveying unit.

9. The label attaching apparatus according to claim 6, wherein
in a case where the attachable region determination unit cannot determine the attachable region on the adherend, the adherend is caused to retract to an outside of the label attaching apparatus without attaching the label to the adherend for which the attachable region cannot be determined.

10. The label attaching apparatus according to claim 6, further comprising:
a printing unit configured to execute printing on the label, wherein
the label subjected to printing by the printing unit is attached to the adherend.

11. The label attaching apparatus according to claim 6, wherein
the label holding unit is formed to be stretchable in an attachment direction in which the label is attached to the adherend.

12. A label attaching method for attaching a label to an adherend, comprising:
measuring a shape of the adherend to be conveyed;
determining an attachable region of the label on the adherend based on the shape; and
attaching the label to the attachable region.

13. A program executable by a computer of a label attaching apparatus for attaching a label to an adherend, the program causing the computer to execute:
a procedure of measuring a shape of the adherend to be conveyed; and
a procedure of determining an attachable region of the label on the adherend based on the shape.
